(19) United States
(12) Patent Application Publication
(10) Pub. No.: US 2021/0409404 A1
(43) Pub. Date: Dec. 30, 2021

(54) ATTESTATION FORWARDING

(71) Applicant: Arm Cloud Technology, Inc., San Jose, CA (US)

(72) Inventors: Mathias Sven Lucien Alain BROSSARD, Austin, TX (US); Derek Del MILLER, Austin, TX (US); Dominic Phillip MULLIGAN, Cottenham (GB)

(21) Appl. No.: 16/914,948

(22) Filed: Jun. 29, 2020

(51) Int. Cl. H04L 29/06; H04L 29/08

(52) U.S. Cl. CPC H04L 63/0884; H04L 63/0876; H04L 67/28; H04L 63/20; H04L 63/0823

(57) ABSTRACT

There is provided a data processing system and method. The system includes challenge circuitry for issuing a challenge to a service device and for receiving a response to the challenge. Forwarding circuitry forwards at least part of the response to a selected one of a plurality of attestation systems and receives a success indication from the selected one of the plurality of attestation systems regarding whether the service device has been attested by the selected one of the plurality of attestation systems. Request circuitry receives a request to provide an attestation of the service device, and to provide the attestation in dependence on the success indication.

### TECHNICAL FIELD

The present disclosure relates to data processing.

### DESCRIPTION

Attestation allows an entity (an attestee) to be assured about the hardware and/or software configuration of a particular platform by a third party (the attestor that operates as part of an attestation system). However, this can cause difficulties since there may be a number of different attestation systems and the attestee might require that a specific system is used. This in turn would require the entity that is being attested to be compatible with each attestation system, which places a large burden on the developer of the platform. Furthermore, if the attestation system for which the platform is designed were to become inoperative, then the platform could become unusable without being reconfigured.

### SUMMARY

Viewed from a first example configuration, there is provided a data processing system comprising: challenge circuitry to issue a challenge to a service device and to receive a response to the challenge; forwarding circuitry to forward at least part of the response to a selected one of a plurality of attestation systems and to receive a success indication from the selected one of the plurality of attestation systems regarding whether the service device has been attested by the selected one of the plurality of attestation systems; and request circuitry to receive a request to provide an attestation of the service device, and to provide the attestation in dependence on the success indication.

Viewed from a second example configuration, there is provided a data processing method comprising: issuing a challenge to a service device; receiving a response to the challenge; forwarding at least part of the response to a selected one of a plurality of attestation systems; receiving a success indication from the selected one of the plurality of attestation systems regarding whether the service device has been attested by the selected one of the plurality of attestation systems; and receiving a request to provide an attestation of the service device, and to provide the attestation in dependence on the success indication.

Viewed from a third example configuration, there is provided a data processing apparatus comprising: challenge circuitry to issue a challenge to a service device and to receive a response to the challenge, wherein the response includes a set of policies that the service device complies with according to an attestation server, the set of policies being signed using a signature of a data processing system that is adapted to communicate with the attestation server; and comparison circuitry to validate the signature and when the signature is validated, to determine whether the set of policies comprises a desired policy of the data processing apparatus, wherein the policies indicate requirements regarding at least one of the attestation system and the service device.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus and a data processing system in accordance with some embodiments;

FIG. 2 illustrates an example flow of communication in accordance with some embodiments;

FIG. 3 illustrates an example flow of communication in accordance with some embodiments;

FIG. 4 illustrates an example flow of communication in accordance with some embodiments;

FIG. 5 illustrates an example flow of communication in accordance with some embodiments;

FIG. 6 illustrates an example flow of communication in accordance with some embodiments;

FIG. 7 illustrates an example flow of communication in accordance with some embodiments;

FIG. 8 schematically illustrates a data processing apparatus and a data processing system in accordance with some embodiments; and

FIG. 9 illustrates an example flow of communication in accordance with some embodiments;

### DESCRIPTION OF EXAMPLE EMBODIMENTS

Before discussing the embodiments with reference to the accompanying figures, the following description of embodiments is provided.

In accordance with one example configuration there is provided a data processing system comprising: challenge circuitry to issue a challenge to a service device and to receive a response to the challenge; forwarding circuitry to forward at least part of the response to a selected one of a plurality of attestation systems and to receive a success indication from the selected one of the plurality of attestation systems regarding whether the service device has been attested by the selected one of the plurality of attestation systems; and request circuitry to receive a request to provide an attestation of the service device, and to provide the attestation in dependence on the success indication.

The data processing system could, for instance, take the form of a ‘proxy’ attestation system, which is able to provide attestation of particular platforms. The challenge circuitry issues a challenge to a service device (e.g. a platform to be attested). A response to the challenge (a challenge response) is then provided by the service device. This response could be such that, for instance, it can only be provided by the platform. The challenge response could itself be or contain a first attestation token used by the platform with one of the ‘native’ attestation servers. This is received by the data processing system, and at least part of the response (e.g. the first attestation token) is forwarded to at least one of several ‘native’ attestation servers. Those of the ‘native’ attestation systems that have been selected to have the at least partial response forwarded can reply with a success indication regarding the attestation of the platform. This success indication need not be a Boolean (yes/no; true/false, pass/fail, etc.). The success indication could, for instance, be implicit in the response made by the ‘native’ attestation system. The success indication could be further information regarding the platform that is provided by the ‘native’ attestation system, or could be a set of conditions under which the attestation is valid. At this point, the data processing system knows the extent to which the platform has been attested by the ‘native’ attestation system. Consequently, when request circuitry of the data processing system receives a request to provide attestation of the service device (e.g. platform) from an attestee, the attestation can be provided based on the success indicator that was received. For instance, if the success indicator indicated success then the attestation can be provided. If the success indicator indicated failure then the attestation can be refused. If the success indicator indicated conditional success, then the attestation can be provided if the conditions are met. In this way, the attestee and the platform (e.g. service device) need not be directly configured to work with any of the ‘native’ attestation systems. Instead of the attestee having to communicate with and support different attestation systems for all the platforms it works with, it only needs to support the data processing system, which handles the ‘native’ attestation systems itself.

In some examples, the data processing system comprises policy storage circuitry, adapted to store at least one policy; and the request circuitry is adapted to provide the attestation in dependence on the at least one policy. Policies can be made in respect of attestation servers (e.g. which attestation systems can be used, under what circumstances, etc.), in respect of service devices (e.g. the requirements of the service device) or in respect of the proxy attestation server itself (e.g. whether attestation should be automatically refused or accepted).

In some examples, the at least one policy indicates the selected one of the plurality of attestation systems. These examples can therefore be used to specify which of the ‘native’ attestation systems the at least partial challenge response is forwarded. This policy could use more local attestation systems in preference to more global attestation systems, for instance, thereby allowing a local provider to override a global policy. In other situations, the policy could be used to ban or prohibit a particular attestation system from being used, or to prefer the use of specialised attestation systems for particular attestations.

In some examples, the response to the challenge indicates the selected one of the plurality of attestation systems. In these examples, the platform itself indicates the attestation system that is to be used. This could be useful in a situation where the platform is specifically designed with a particular attestation system in mind, or where one particular attestation system is known to work better (e.g. more reliably) than another.

In some examples, the selected policy denies the use of a banned attestation system in the plurality of attestation systems. There are a number of ways in which the policies can control the use of the attestation systems. However, in these examples, the policy denies the use of a particular attestation system. This denial could be conditional or unconditional. In this way, it is possible to deny the use of an attestation system that is compromised or that is deemed to offer unsatisfactory attestation.

In some examples, the policy storage circuitry is adapted to store a plurality of policies; and the request comprises an indication of a selected policy in the plurality of policies that is to be applied; and the request circuitry is adapted to provide the attestation in dependence on the selected policy. In these examples, the attestee itself indicates which of the policies is to be applied. This makes it possible for the attestee to dictate how attestation is to be performed. For instance, the attestee may require that particular ‘native’ attestation systems are used, or could place requirements on the level or degree to which attestation is provided. The attestee could also specify policies that import requirements regarding the service device. This can be achieved in a number of ways. In particular, the data processing system could, on receiving the challenge response containing a first attestation token, attempt to obtain attestation for the platform immediately using the first attestation token. Once the policy is selected by the attestee, the obtained attestations are then each considered based on the selected policy. In other examples, the attestation is not performed until the attestee specifies a policy to be used and then based on the policy, attestation with a certain ‘native’ attestation system is carried out. The former approach may have a lower latency since at the time an attestation request is sent, it is possible to respond with attestation if it can be provided. However, the latter approach offers a reduction in bandwidth since attestation requests that are unsuitable can avoid being sent. Furthermore, less information need be stored at the data processing system since only relevant (useful) attestation results need to be stored.

There are a number of ways in which the policies can be used, and also in which the success indicator can be used. However, in some examples, the success indicator comprises one or more service device characteristics; and the at least one policy specifies requirements of the service device characteristics. Such characteristics could relate to, for instance, the firmware version or provider, or could relate to hardware characteristics of the platform. For instance, the policy could require that the platform provides encrypted memory. Such a requirement can either be considered by the data processing system, or can be passed to the ‘native’ attestation systems when attestation for the platform is sought. This makes it possible to only attest to particular platforms having the requested characteristics. Other examples of characteristics could relate to the manufacturing date, manufacturing quality, the location of manufacturing, the total runtime (or lifetime) of the platform, the firmware version, and so on.

In some examples, the requirements of the service device characteristics are hardware requirements. For instance, the characteristics could relate to the type of chip set, the processor type, brand, or features, types or amounts of particular resources available (e.g. 2 MB of secure memory must be available), and so on.

In some examples, the forwarding circuitry is adapted to forward the at least part of the response to each of the plurality of attestation systems and to receive a plurality of success indicators from each of the attestation systems regarding whether the service device has been attested by that attestation system. In these examples, the at least partial challenge response is sent to each of the attestation systems, each of which can make its own independent determination as to whether attestation can be provided or not, before responding with a success indicator. This can therefore result in the data processing system receiving a set of responses, each of which could indicate success or failure. The attestation that is forwarded in response to the later request from the attestee can be selected based on the active policy. For instance, if only a single success indicator is received, then the policy could cause that single success to be returned.

In some examples, at least some of the plurality of attestation systems are mirrors; and the forwarding circuitry is adapted to use a backup one of the mirrors in response to a communication error with a primary one of the mirrors. In response to a communication error occurring when a given (e.g. selected) one of the attestation systems occurs, the forwarding circuitry is able to use a backup of the given (e.g. selected) attestation systems instead. Accordingly, the backup attestation system acts as a mirror for when a communication error occurs thereby increasing availability and resilience of the attestation system. The use of such a backup provision can be hard-coded into the forwarding circuitry or can be mandated within a policy, for instance.

Although there are a number of different communication errors that might be considered, in some embodiments the communication error is the primary one of the mirrors being unreachable.

In some examples, the at least part of the response is consistent across all of the attestation systems. That is to say that the challenge response can be independent of the ‘native’ attestation systems and therefore contain sufficient information for any of the ‘native’ attestation systems to be used. In some other embodiments, the data processing system can provide an indicator of which ‘native’ attestation systems can be used and the platform/service device provides necessary information for the attestation to occur, based on the set of requirements for each of the specified attestation systems to provide attestation.

In accordance with another example configuration, there is provided a data processing apparatus comprising: challenge circuitry to issue a challenge to a service device and to receive a response to the challenge, wherein the response includes a set of policies that the service device complies with according to an attestation server, the set of policies being signed using a signature of a data processing system that is adapted to communicate with the attestation server; and comparison circuitry to validate the signature and when the signature is validated, to determine whether the set of policies comprises a desired policy of the data processing apparatus, wherein the policies indicate requirements regarding at least one of the attestation system and the service device.

In this example configuration, the data processing system is able to act as a proxy attestation server as explained above. However, the data processing apparatus, that seeks attestation of a target system or service device need not communicate directly with the proxy attestation server. Instead, the data processing system is able to produce a set of policies that are met by the target system. These are signed by the data processing system so that they cannot be modified and then sent to the target system. When attestation of the target system is sought, the target system is able to provide the signed set of policies that the target system meets to the attestee. The attestee can then determine whether a particular (desired) policy falls within that list. If so, then attestation is achieved.

Particular embodiments will now be described with reference to the figures.

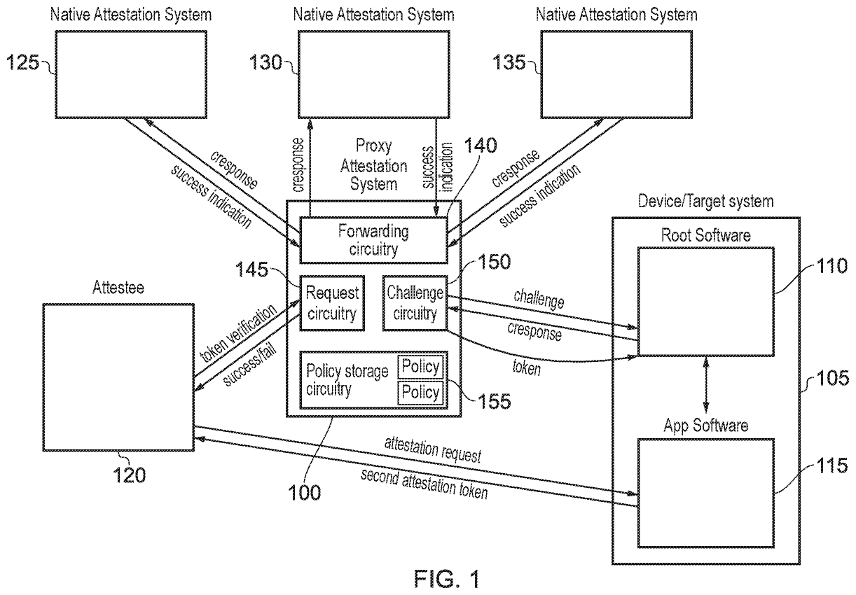

FIG. 1 schematically illustrates a proxy attestation system 100 and attestee 120 in accordance with some embodiments. The proxy attestation system 100 is an example of the claimed data processing system. The proxy attestation system 100 includes challenge circuitry 150, which is responsible for issuing a challenge to root software 110 of a device/target system or platform 105. The root software 110 could take the form of an operating system or other privileged software. The device/target system or platform 105 is an example of the claimed service device.

In response to the challenge, the root software 110 provides a corresponding challenge response (cresponse), which is received by the challenge circuitry 150. The cresponse could be or could contain a first attestation token, for instance. All or part of the cresponse is forwarded to one or more native attestation systems 125, 130, 135, which perform the attestation using the cresponse. The cresponse contains sufficient information (e.g. the first attestation token) for each native attestation system 125, 130, 135 to decide whether the device/target system 105 should be attested. For instance, this process could include consulting databases of known systems for which attestation can be provided. Each native attestation system 125, 130, 135 provides a success indication back to the forwarding circuitry. The success indication could take a number of forms and need not be a Boolean, but either implicitly or explicitly indicates whether the attestation has been successful or not. For instance, the success indication could include hardware information regarding the platform 105, which is either available in a database of the native attestation system 125, 130, 135, or which is provided by the platform 105 itself as part of its cresponse.

When the attestee 120 seeks to attest the app software 115 on the platform 105, it sends an attestation request to the app software 115. The app software 115 communicates with the root software 110 on the platform 105 in order to request a second attestation token using the attestation credentials of the device 105 (provided by the proxy attestation system 100). The app software 115 passes this on to the attestee 120, which requests token verification from the proxy attestation system 100. The proxy attestation system 100 contains request circuitry 145 to receive a token verification request from the attestee 120. The token verification request contains the second attestation token provided by the app software 115. The proxy attestation system therefore responds to the verification request with a success/fail indication depending on whether the second token was valid or not.

Policy storage circuitry 155 is also provided in the proxy attestation system 100 in order to store one or more policies. The policies can indicate how the success indications are acquired, mediated, and used by the proxy attestation system 100 and can provide conflict resolution when different success indications disagree. The policies can also be used to specify particular requirements of a platform 105 in order to achieve attestation. There are a number of ways in which one or more of policies can be invoked, as will be discussed later.

Note that FIG. 1 illustrates the flow of attestation in a general sense. In some embodiments, the information provided at particular steps could be more extensive and in some cases, the ordering in which communications are issued could be varied.

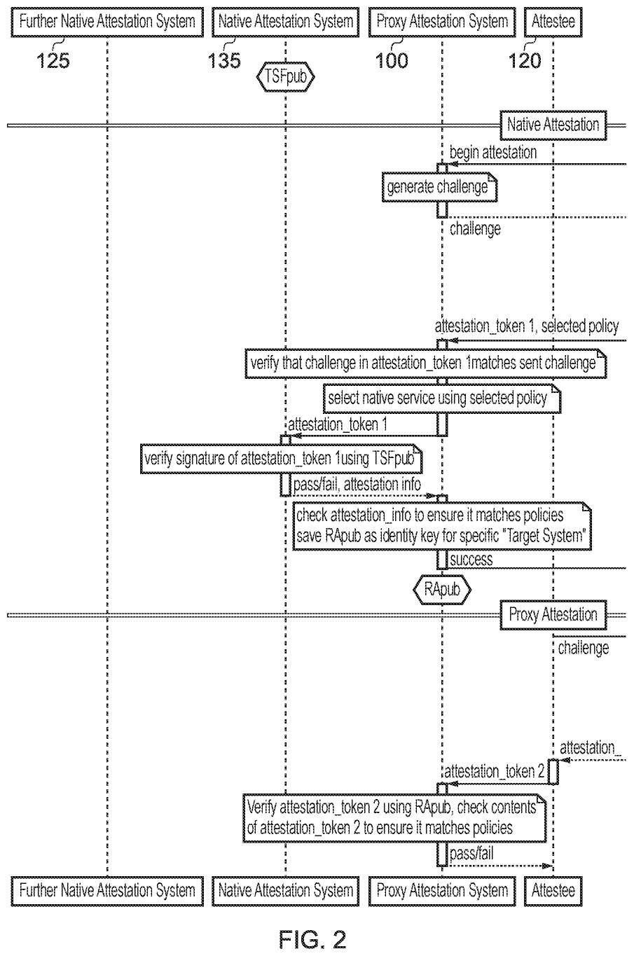

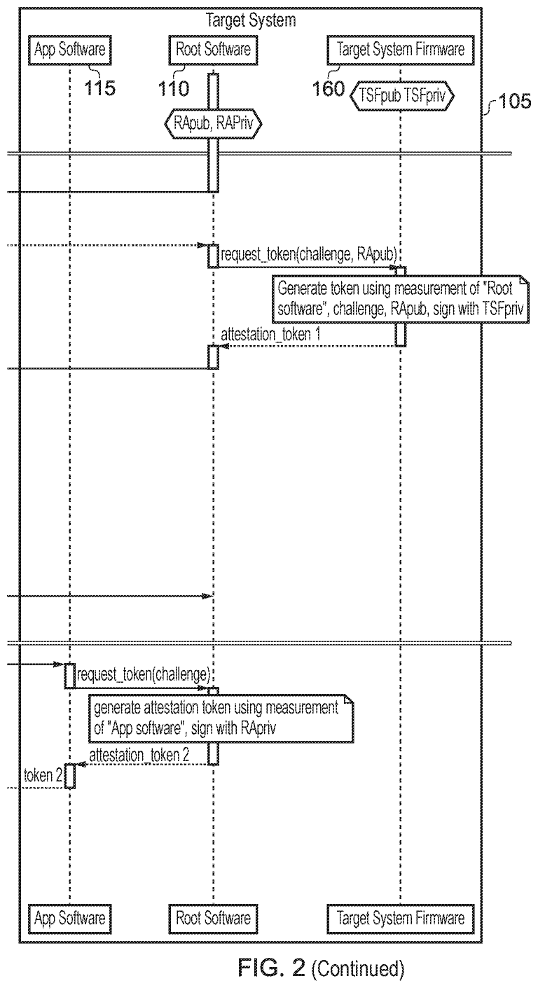

FIG. 2 illustrates an example flow of communication between a native attestation system 135, a further native attestation system 125, a proxy attestation system 100, an attestee 120, and a target system 105 for which attestation is sought, including root software 110, app software 115, and firmware 160.

The root software 110 on the device 105 freshly generates the key pair (RApub, RApriv). The firmware 160 also makes use of a key pair (TSFpub, TSFSpriv). The native attestation system 135 has the public key (TSFpub) for the device 105. When attestation is to begin, the root software 110 on the device 105 sends a message to the proxy attestation system 100 that attestation is to begin. The proxy attestation system 100 responds by generating a challenge, which is issued back to the root software 110 of the device 105. The challenge could take the form of a large (e.g. 128 bit) random or pseudo random number, thereby inhibiting a replay attack from occurring. The root software 110 responds by requesting a token from the firmware 160, by providing the challenge and the root software's public key RApub. The firmware generates a first attestation token (attestation_token1), which includes a measurement of the root software (e.g. a hash of the root software), RApub, and the challenge. The attestation_token1 is signed using TSFpriv, thereby confirming that it originated from the firmware 160. This attestation_token1 forms part of a challenge response, which is sent to the proxy attestation system 100 via the root software 110. A selected one of several policies held at the proxy attestation system 100 is also provided in the challenge response. At the proxy attestation system 100, the challenge in attestation_token_1 is checked to determine whether it matches the sent challenge. If not, this could be indicative that a replay attack is being performed, and the attestation process could be cancelled (with the target system 105 being ignored/blacklisted). Otherwise, one or more native attestation systems 125, 135 are selected for use (e.g. via the policy specified by the root software 110). In this case, the active policy indicates that the native attestation system 135 is to be used and so this system 135 is selected. The attestation_token1 is passed to that native attestation system 135 from the proxy attestation system 100. The native attestation system 135 determines whether or not attestation should be provided based on attestation_token1. In particular, since the native attestation system 135 has a copy of TSFpub, it is possible to confirm that the token that was received originated from the firmware 160 of the device 105, since only the firmware 160 has access to TSFpriv. Furthermore, the measurement of the root software 110 has also been provided. All of this information can be looked up in, for instance, a database of attestable devices/root softwares held by the native attestation system 135. In response to these checks, the native attestation system 135 responds with a success indicator, which in this example is a pass/fail and, in the case of a path, attestation information. On receiving the success indicator, the attestation information is checked to see whether any requirements of the selected policy are met. For example, such requirements could relate to the nature of the native attestation system 135 that performed the attestation, or could relate to the reported requirements of the platform 105.

When an attestee 120 seeks to make use of app software 115 on the target system/platform 105, the attestee 120 issues a challenge to the app software 115. Again, the challenge can be produced by generating a large (e.g. 128 bit) random or pseudo random number, in order to prevent replay attacks. At this point, local attestation occurs between the app software 115 and the root software 110. Provided the root software 110 is agreeable, a second attestation token (attestation_token2) is provided to the app software 115 from the root software 110. The attestation_token2 is generated by measuring the app software 115 and by signing this measurement using RApriv. This is provided to the application 115, which provides it back to the attestee 120, which forwards the second token to the proxy attestation system 100 for verification. Since the proxy attestation system 100 has access to RApub, it is possible for the proxy attestation system 100 to confirm that attestation_token2 was produced by the root software 110 on the device/platform 105. The proxy attestation system 100 can access the body of attestation_token2 to obtain the measurement (e.g. hash) of the application software 115. This can be checked against the active (e.g. selected) policy for instance to ensure that it matches what is recorded at the proxy attestation server 100. A pass/fail indication can then be sent from the proxy attestation system 100 back to the attestee 120.

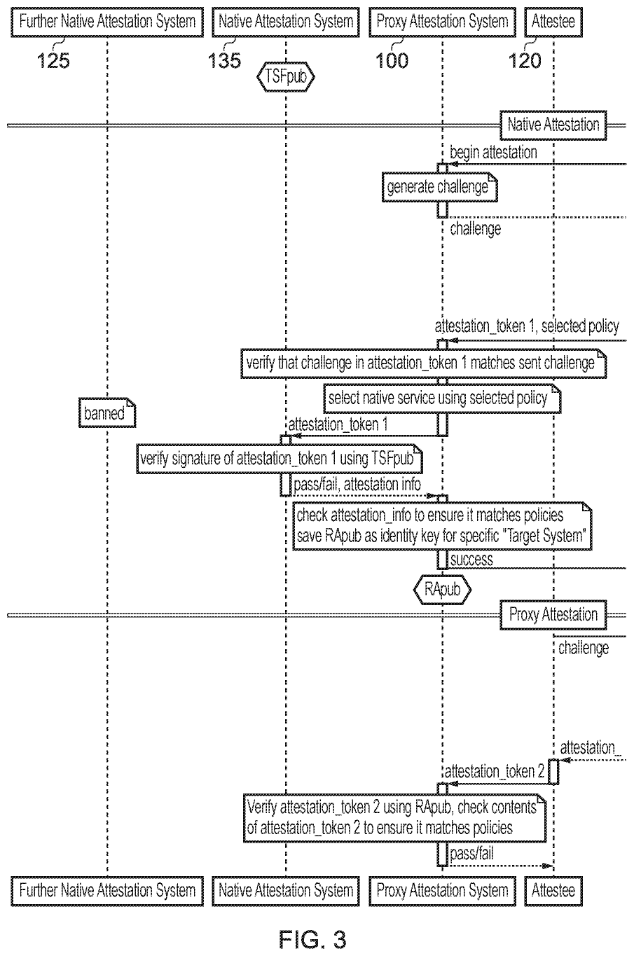

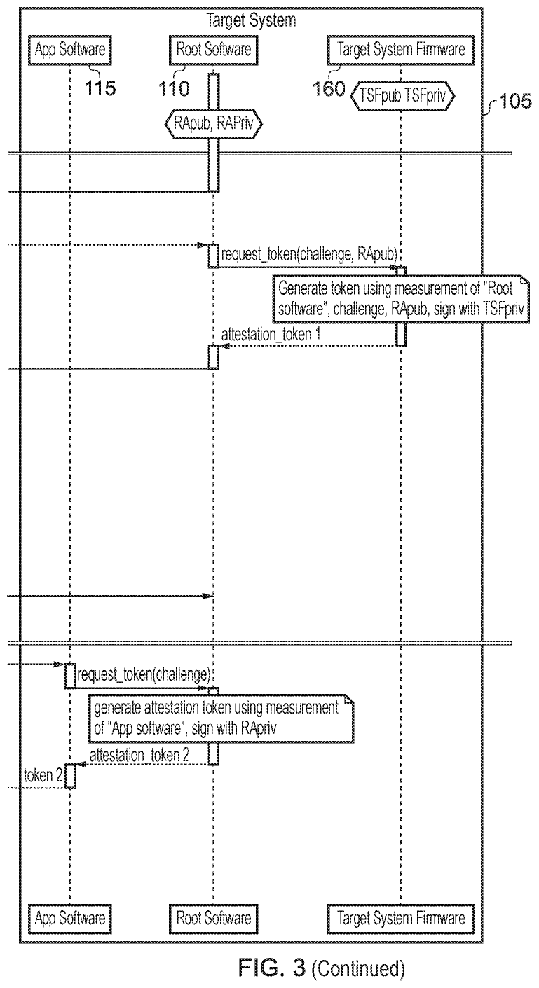

FIG. 3 illustrates a further example flow of communication between a native attestation system 135, a further native attestation system 125, a proxy attestation system 100, an attestee 120, and a target system 105 for which attestation is sought, including root software 110, app software 115, and firmware 160.

Much of the flow of communication in FIG. 3 corresponds with the flow shown in FIG. 2. Of particular interest in this example is that the root software 110 indicates a policy that is to be applied when providing the challenge response comprising the token to the proxy attestation system 100. In this example, the selected policy causes the further native attestation system 125 to be banned so that it cannot be used for attesting to the target system 105. As a consequence, the proxy attestation system uses the native attestation system 135 to perform the attestation of the target system 105 and the flow proceeds as per the flow shown with respect to FIG. 2. This mechanism makes it possible to prevent the use of particular attestation servers. This could be carried out for security reasons (if the further native attestation system 125 becomes untrusted for instance), licensing reasons (if the further native attestation system 125 refuses to attest the target system 105 any longer for instance), or for reasons of efficiency (if, for instance, the further native attestation system 125 has stopped working and it is desirable to prevent time consuming attempts to use it).

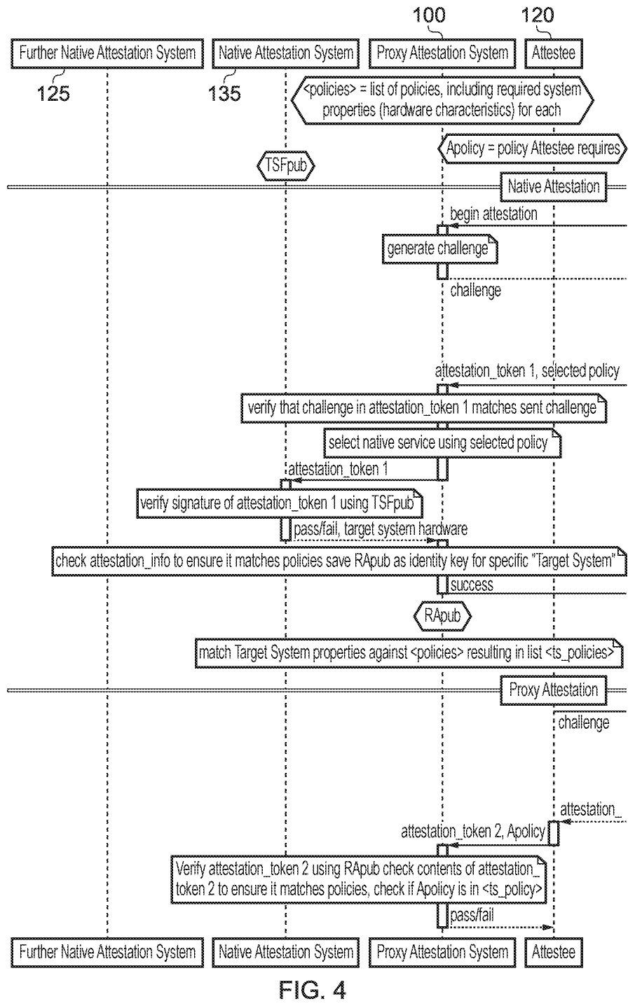

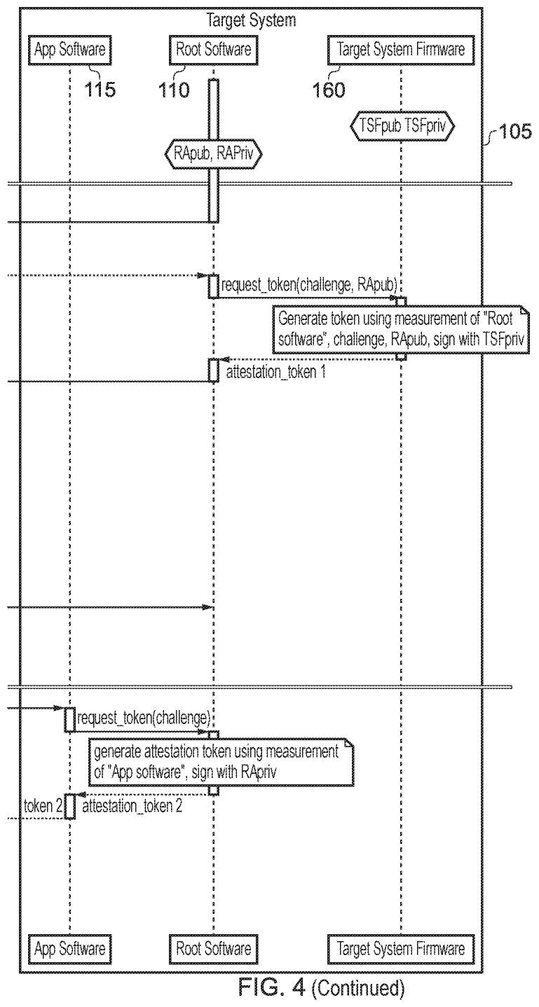

FIG. 4 illustrates a further example flow of communication between a native attestation system 135, a further native attestation system 125, a proxy attestation system 100, an attestee 120, and a target system 105 for which attestation is sought, including root software 110, app software 115, and firmware 160.

In this flow, a plurality of policies exists on the proxy attestation system 100. The attestee 120 has a particular policy (Apolicy) that is required. This policy could, for instance, specify hardware requirements of the target system 105 for which attestation is sought, such as requiring that the target system 105 has secure memory for instance. The flow proceeds as previously discussed with the target system 105 seeking attestation, the proxy attestation system 100 issuing a challenge, and the root software 110 on the target system 105 issuing a first token (attestation_token1). When the first token is forwarded to a selected native attestation system 135, the native attestation system 135 provides attestation information in the form of target system properties (e.g. target system hardware) of the target system 105 together with the pass/fail indicator. Indeed, in some embodiments, the presence of the target system properties could be indicative of a pass while the lack thereof within a given time period could be interpreted as a fail. The properties (e.g. hardware characteristics) of the target system 105 are then compared to each of the policies to see which policies would accept the properties of the target system 105. This is used to form a set ts_policies. The flow then continues as discussed. When the attestee 120 seeks to verify the attestation_token2 that was received from the app software 115, it also provides the identity of Apolicy to the proxy attestation system 100. As part of the proxy attestation system's checks, the proxy attestation system 100 determines whether Apolicy is one of the policies is in ts_policies. That is, the proxy attestation system 100 determines whether Apolicy is one of the policies that will accept the hardware characteristics that were provided for the target system 105. If not, then the attestation fails. If so, then the attestation passes or fails in dependence on the other tests performed by the proxy attestation system 100.

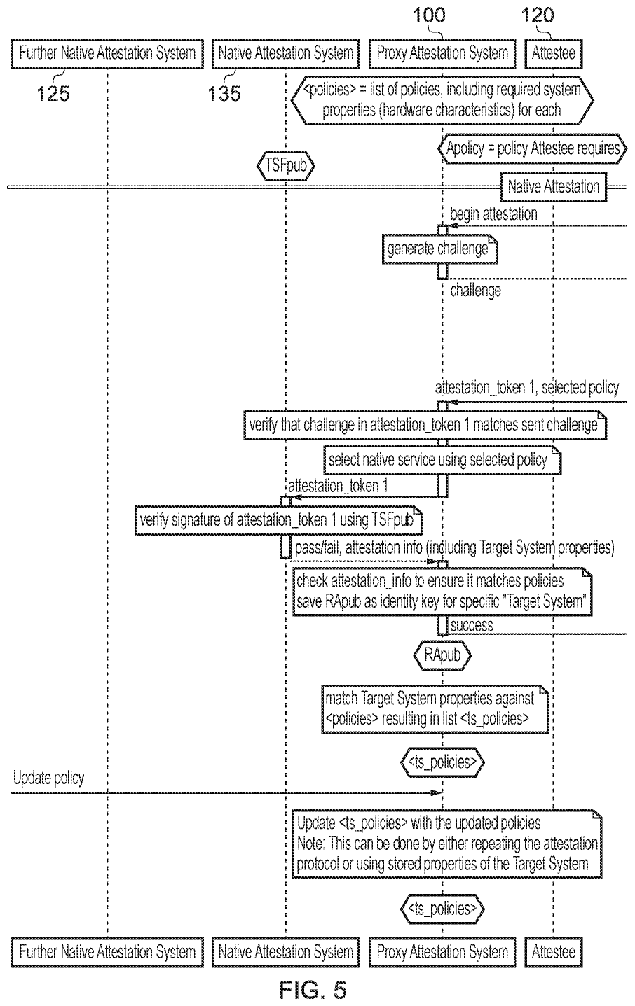

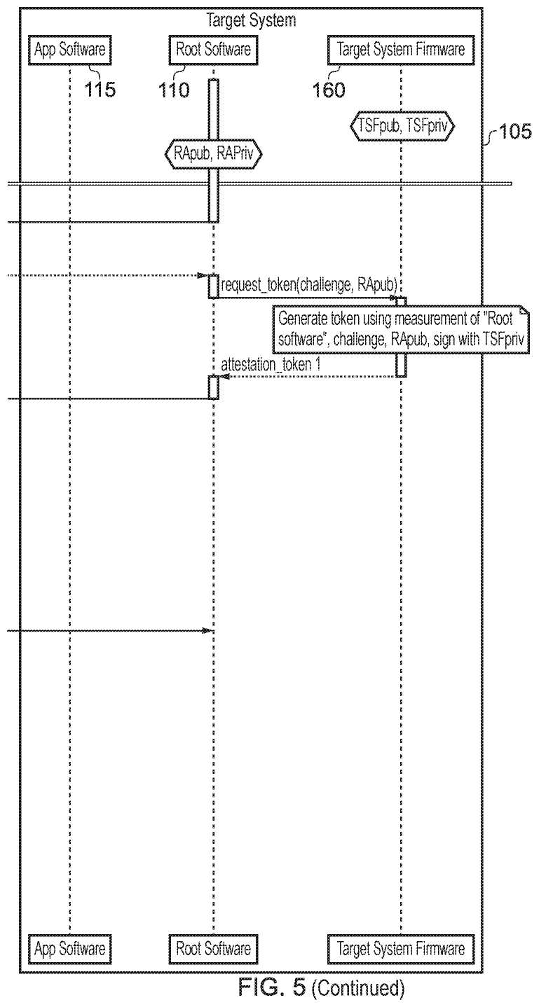

FIG. 5 illustrates an additional element in the example flow of FIG. 4.

In particular, FIG. 5 illustrates that a policy (or policies) can be updated. This could, for instance, be used to change security requirements on-the-fly. In particular, when one or more updated policies are added to the proxy attestation system 100 there are a number of ways in which this can be handled. In one example, the attestation process can be restarted for each target system 105 for which attestation has been carried out. For instance, current attestations can be invalidated and the target system 105 can either pre-emptively request attestation or can be prompted to request attestation by the proxy attestation system 100 or the attestee 120 if the attestee 120 becomes aware of the changed policies. Alternatively, if the target system policies that were obtained from the native attestation system 135 are stored then these can be compared to the revised set of policies in order to regenerate ts_policies. In either event, the flow proceeds as illustrated in FIG. 4.

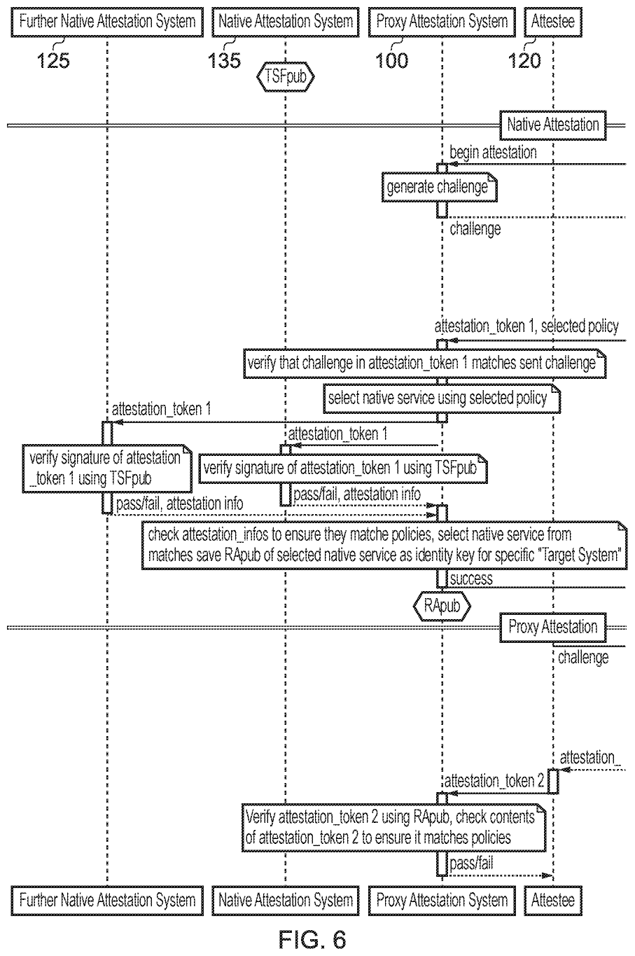

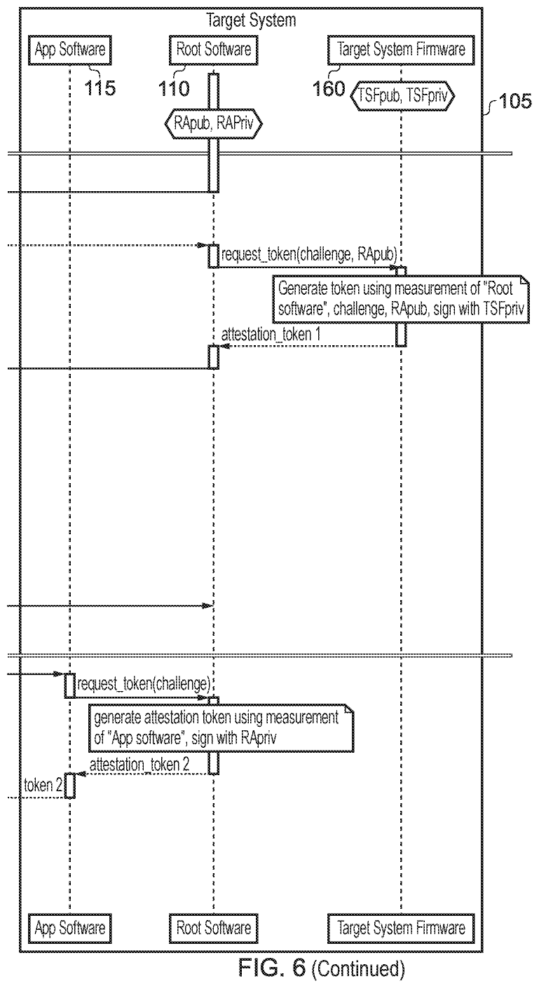

FIG. 6 illustrates a further example flow of communication between a native attestation system 135, a further native attestation system 125, a proxy attestation system 100, an attestee 120, and a target system 105 for which attestation is sought, including root software 110, app software 115, and firmware 160.

FIG. 6 considers a situation in which, after having received the first token from the root software 110, each of the further native attestation system 125 and the native attestation system 135 is sent the first token by the proxy attestation system 100 in order to produce and return a plurality of success indicators. There are a number of ways in which these success indicators can be used by the proxy attestation system 100. In some systems, a majority ‘vote’ could be used to determine whether attestation can be provided by the proxy 100. This makes it possible to spread risk by requiring a number of systems to be able to attest to a target system 105 before attestation can be provided by the proxy 100. In other systems, even a single success is sufficient for the target system 105 to acquire attestation. In still other systems, the exact conditions are set according to a policy. In the example shown in FIG. 6, the active policy (which could be selected by the owner of the proxy attestation system 100 or could be selected by the attestee 120 for instance) selects the native attestation system 125, 135 to provide the attestation system based on which of the native attestation systems 125, 135 provides a pass. For instance, the policy might select the nearest or most convenient native attestation system 125, 135 or could select one that provides the most information about the target system 105 as a result of the attestation succeeding, or the first native attestation system 125, 135 to provide success could be selected.

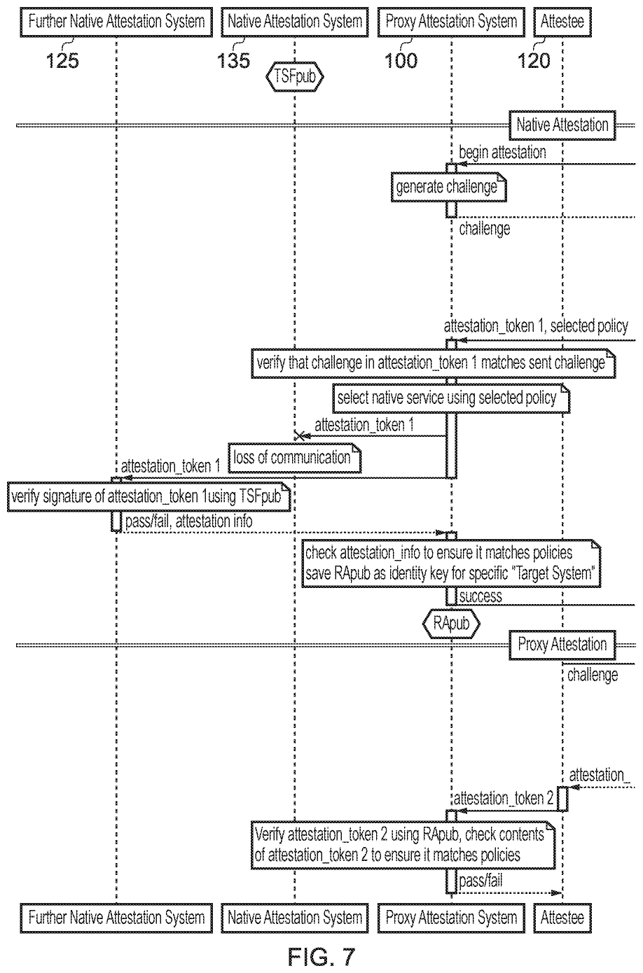

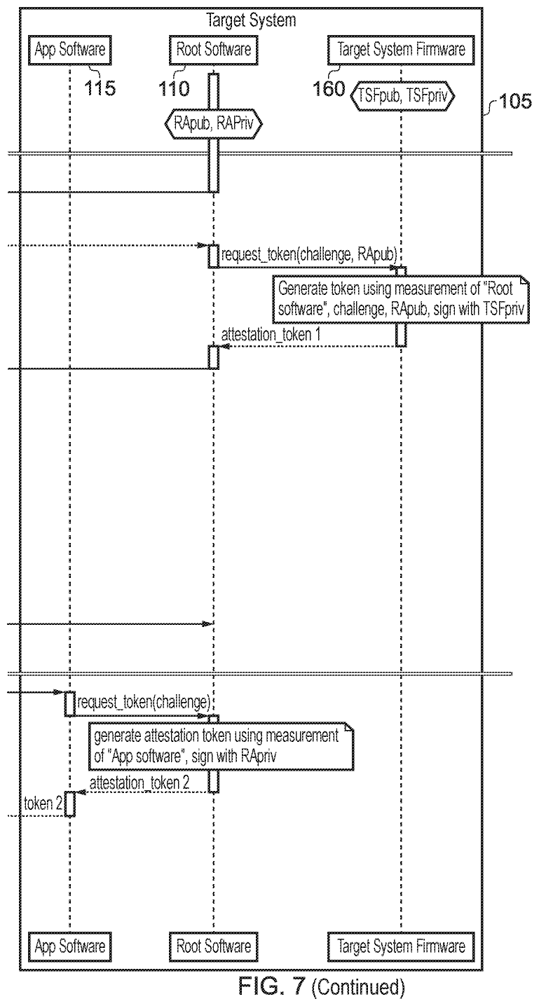

FIG. 7 illustrates a further example flow of communication between a native attestation system 135, a further native attestation system 125, a proxy attestation system 100, an attestee 120, and a target system 105 for which attestation is sought, including root software 110, app software 115, and firmware 160.

FIG. 7 particularly illustrates the use of mirrors. In this situation, a mirror native attestation system 125 is provided in order to replicate the functionality of native attestation system 135. The mirror native attestation system 125 could be provided in a location that is geographically closer (e.g. more responsive) to the attestee 120 or could simply be provided as a redundant system to the native attestation system 135. In either event, in this example, after receiving the first token and selecting the native attestation system 135 for use, a communication error occurs in the form of the native attestation system 135 becoming unreachable. As a consequence, the proxy attestation system 100 instead communicates the token to the mirror native attestation server 125, which response with the success indicator. The flow then proceeds as previously described.

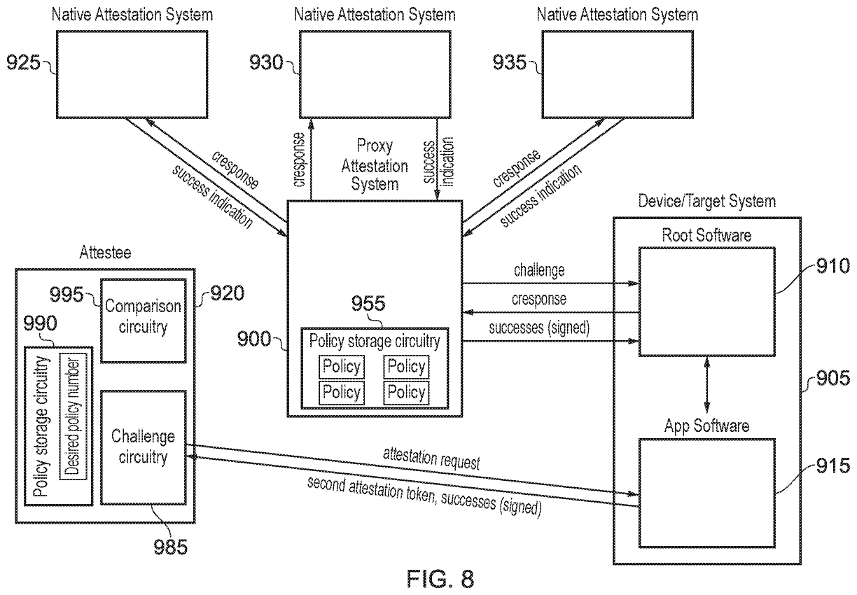

FIG. 8 schematically illustrates a proxy attestation system 900 and attestee 920 in accordance with some embodiments. The proxy attestation system 900 is an example of the claimed data processing system and the attestee 920 is an example of the claimed data processing apparatus. As before, the proxy attestation system 900 issues a challenge to root software 910 of the device/target system 905. This responds with a challenge response (cresponse), which again contains a first attestation token. All or part of the cresponse is forwarded by the proxy attestation system 900 to one or more of a plurality of native attestation systems 925, 930, 935, each of which provides a success indication. The list of successes is compared to a list of policies in policy storage circuitry 955 and the successful policies are signed and sent by the proxy attestation system 900 to the root software 910 on the device 905. In due course, when the attestee 920 seeks attestation of app software 915 on the device 905, the app software 915 communicates with the root software 910 in order to gain the use of the attestation token. The attestation token and the signed list of successful policies are then forwarded by the app software 915 to the attestee 920. Here, the attestee confirms the signature of the signed list of successes and determines whether a desired policy stored in policy storage circuitry 990 is in the list of successful policies sent by the app software 915. If so, the attestation succeeds.

In this version of the system, the attestee 920 need not communicate with the proxy attestation system 900 (except perhaps to obtain a list of possible policies). Instead, the device/target system 905 provides a list of policies that are met via its attestation. These are signed by the proxy attestation system 900 so that the list cannot be modified. The list of successes is sent to the attestee at the time of attestation to the attestee so that the attestee can determine whether its requirements are met by comparing the list of successes to its own desired policy or policies to see if they are found in the list. If they are found in the list, then the attestation succeeds. Otherwise, the attestation fails.

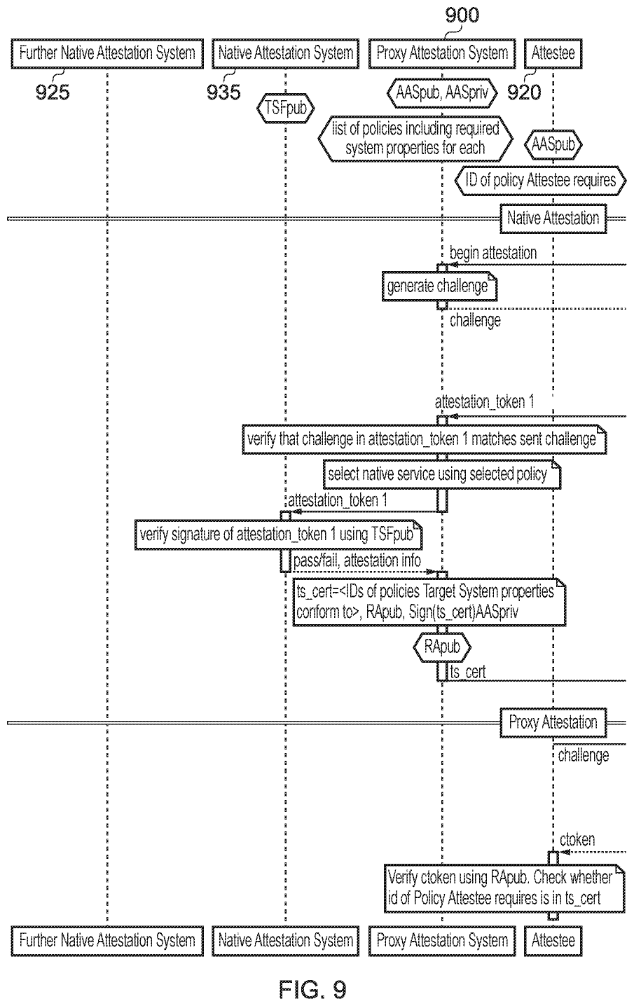

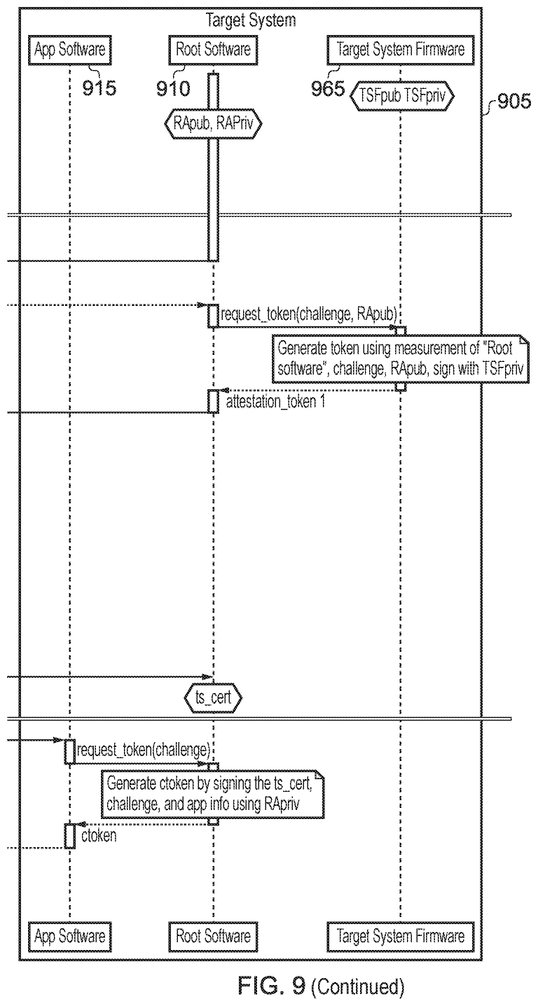

FIG. 9 shows the flow in more detail. The proxy attestation system 900 has a public/private key pair (AASpub, AASpriv) for producing the signed set of successful policies. In addition, the proxy attestation system 900 has a set of policies, each of which specifies particular system characteristics. The attestee has access to the public key AASpub and also knows the ID of the various policies that it wishes to apply. The attestation process begins in the manner previously discussed. In particular, the root software 910 sends a begin_attestation notification to the proxy attestation system 900, which generates a challenge. The challenge is then sent to the root software 910, which generates a first token using (as before. This token is then sent to the proxy attestation system 900, which forwards the token as part of a challenge response to one or more native attestation systems 935 (again, as previously discussed). The native attestation system 935 responds with a success indicator, together with a set of platform properties of the target system 905. Validation is performed, as previously described. The proxy attestation system then generates a set ts_cert, which contains a list of policies (or policy IDs) whose system requirements are met by the target system 905 and RApub. This is determined using the platform properties that are received from the native attestation system 935. Each of these policies/policy IDs is signed using AASpriv. ts_cert is then sent to the root software 910.

When attestation of the app software 915 is sought by the attestee 920, the attestee 920 issues a challenge to the app software 915 as previously described. Local attestation is then performed by the app software 905 sending an attestation request (together with the challenge) to the root software 910. The root software 910 responds with a ctoken (a second attestation token). The ctoken contains ts_cert, the challenge, and information regarding the app software 915. All of this is signed using RApriv (the private key of the root software 910). The ctoken is forwarded by the app software 915 to the attestee 920. The attestee 920 verifies the signature of ctoken (e.g. using RApub). The ID of the policy that the attestee 920 requires is then checked to see if it lies within ts_cert (the successful policies). If so, attestation is successful. Otherwise, attestation has failed. In this way, the attestee 920 need not communicate directly with the proxy attestation system 900 while still making use of its capabilities to act as an intermediary between the native attestation systems 925, 935.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

We claim:

1. A data processing system comprising:
challenge circuitry to issue a challenge to a service device and to receive a response to the challenge;
forwarding circuitry to forward at least part of the response to a selected one of a plurality of attestation systems and to receive a success indication from the selected one of the plurality of attestation systems regarding whether the service device has been attested by the selected one of the plurality of attestation systems; and
request circuitry to receive a request to provide an attestation of the service device, and to provide the attestation in dependence on the success indication.

2. The data processing system according to claim 1, comprising:
policy storage circuitry, adapted to store at least one policy; and
the request circuitry is adapted to provide the attestation in dependence on the at least one policy.

3. The data processing system according to claim 2, wherein
the at least one policy indicates the selected one of the plurality of attestation systems.

4. The data processing system according to claim 1, wherein
the response to the challenge indicates the selected one of the plurality of attestation systems.

5. The data processing system according to claim 1, wherein
the selected policy denies the use of a banned attestation system in the plurality of attestation systems.

6. The data processing system according to claim 2, wherein
the policy storage circuitry is adapted to store a plurality of policies; and
the request comprises an indication of a selected policy in the plurality of policies that is to be applied; and
the request circuitry is adapted to provide the attestation in dependence on the selected policy.

7. The data processing system according to claim 2, wherein
the policy storage circuitry is adapted to store a plurality of policies; and
the request circuitry is adapted, in response to the request to provide the attestation, to provide an indication of which of the plurality of policies have requirements that are met by the service device.

8. The data processing system according to claim 2, wherein
the success indicator comprises one or more service device characteristics; and
the at least one policy specifies requirements of the service device characteristics.

9. The data processing system according to claim 8, wherein
the requirements of the service device characteristics are hardware requirements.

10. The data processing system according to claim 1, wherein
the forwarding circuitry is adapted to forward the at least part of the response to each of the plurality of attestation systems and to receive a plurality of success indicators from each of the attestation systems regarding whether the service device has been attested by that attestation system.

11. The data processing system according to claim 1, wherein
at least some of the plurality of attestation systems are mirrors; and
the forwarding circuitry is adapted to use a backup one of the mirrors in response to a communication error with a primary one of the mirrors.

12. The data processing system according to claim 11, wherein
the communication error is the primary one of the mirrors being unreachable.

13. The data processing system according to claim 1, wherein
the at least part of the response is consistent across all of the attestation systems.

14. A data processing method comprising:
issuing a challenge to a service device;
receiving a response to the challenge;
forwarding at least part of the response to a selected one of a plurality of attestation systems;
receiving a success indication from the selected one of the plurality of attestation systems regarding whether the service device has been attested by the selected one of the plurality of attestation systems; and
receiving a request to provide an attestation of the service device, and to provide the attestation in dependence on the success indication.

15. A data processing apparatus comprising:
challenge circuitry to issue a challenge to a service device and to receive a response to the challenge, wherein the response includes a set of policies that the service device complies with according to an attestation server, the set of policies being signed using a signature of a data processing system that is adapted to communicate with the attestation server; and
comparison circuitry to validate the signature and when the signature is validated, to determine whether the set of policies comprises a desired policy of the data processing apparatus, wherein
the policies indicate requirements regarding at least one of the attestation system and the service device.
